(19) United States
(12) Patent Application Publication
(10) Pub. No.: US 2014/0054945 A1
(43) Pub. Date: Feb. 27, 2014

(54) Headrest System

(71) Applicant: INNOVATIONS 4 U, LLC, Tampa, FL (US)

(72) Inventor: Jesus Jose Alfonso, Trinity, FL (US)

(21) Appl. No.: 13/972,340

(22) Filed: Aug. 21, 2013

Related U.S. Application Data
(60) Provisional application No. 61/691,838, filed on Aug. 22, 2012.

(51) Int. Cl. B60N 2/48

(52) U.S. Cl. CPC B60N 2/4879
USPC 297/393

(57) ABSTRACT

Disclosed is an infant's headrest system that is adapted to be secured to a car seat, booster seat, or high chair. The headrest includes two halves that can be independently secured to the seat and that can be joined to one another via hook and pile fasteners. The two ends can be brought together around the periphery of an infant's head to prevent the infant's head from bobbing forward while they are asleep.

### RELATED APPLICATION DATA

This application claims priority to co-pending application Ser. No. 61/691,838 entitled “Infant Headrest System” filed on Aug. 22, 2012. The contents of this co-pending application are incorporated herein for all purposes.

### TECHNICAL FIELD

This disclosure relates to a headrest. More particularly, the present disclosure relates to an headrest with opposing sides that can be secured around the head of the user.

### BACKGROUND OF THE INVENTION

As any caregiver knows, the proper orientation of a child's head is of critical importance. This is especially true for infants, who often cannot support the weight of their own head. As a result caregivers must ensure that an infant's head is properly supported at all times.

Problems arise, however, when an infant is resting or sleeping, such as in a highchair or car seat. In these situations, the infant's head tends to repeatedly slam down or crash to the side in an alarming manner as the infant helplessly attempts to position his or her head upright for maximum comfort. This constant struggle for comfort may interrupt the infant's sleep. If the infant is in a car seat, the caregiver is often in the front seat and unable to assist the infant. A caretaker witnessing a struggling infant is set into panic mode and will likely try to find a place to pull off the road to assist the infant or adjust the car seat. Worst yet, some caretakers may attempt to do this while driving, all the while not paying attention to the task of driving. Not only does the panic of the caretaker lead to an increased likelihood of an accident, but the infant may be subject to more severe injuries if the infant's head is not properly positioned during an accident.

These problems also arise with adults trying to sleep in an upright or less than fully reclined position. For example, airline passengers often find it difficult to fall asleep within the confines of their individual seat. If the passenger does fall asleep, their head often falls to one side or another disturbing the adjacent passenger. The inability to find a comfortable, seated position often makes in-flight sleep an impossibility.

What is needed, therefore, is a system for avoiding the aforementioned problems by securing a user's head when seated. The headrest system of the present disclosure substantially fulfills these and other needs.

### SUMMARY OF THE INVENTION

The disclosed system has several important advantages. For example, the system ensures that a user's head is properly oriented in a vertical or near vertical orientation while resting or sleeping.

A further possible advantage is realized by providing a headrest that allows a user to rest comfortably without bending his or her neck.

Still yet another possible advantage of the present system is achieved by providing a headrest that can be easily retrofitted to an existing car seat, booster seat, or high chair.

A further advantage is realized by providing a headrest that can be fitted onto an airline seat.

Still yet another possible advantage of the present system is attained by providing a head rest that is adapted to be adjustably secured around the periphery of a user's head.

Another advantage is accomplished by providing a headrest can be secured about the head of an infant to prevent the infant's head from moving while resting or sleeping.

It is also an advantage to provide a headrest that can be secured about the head of an adult user, while the user is seated in an airplane or automobile, and thereby prevent the user's head from moving while resting or sleeping.

Various embodiments of the invention may have some, none, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a perspective view of the headrest of the present disclosure.

FIG. 2 is a front elevational view of the headrest of the present disclosure.

FIG. 3 is a rear elevational view of the headrest of the present disclosure.

FIG. 4 is an end view of the headrest of the present disclosure.

FIG. 5 is an end view of the headrest of the present disclosure.

FIG. 6 is a bottom view of the headrest of the present disclosure.

FIG. 7 is a top view of the headrest of the present disclosure.

FIG. 8 is a perspective view of the headrest positioned upon a car seat.

FIG. 9 is a perspective view of an alternative embodiment of the headrest of the present disclosure.

FIG. 10 is a perspective view of the back of the headrest of FIG. 9.

FIG. 11 is a perspective view of the front of the headrest of FIG. 9.

FIG. 12 is a sectional view taken along line 12-12 of FIG. 11.

FIG. 13 illustrates a car seat for use in connection with the present invention.

Parts List

| | |
|---|---|
| 10 | System |
| 22 | First Pillow |
| 24 | Second Pillow |
| 26 | First Wing |
| 28 | Second Wing |
| 32 | Upper Edge First Wing |
| 34 | Upper Edge Second Wing |
| 36 | Velcro Attachments for Pillows |
| 38 | Velcro Attachments for Wings |
| 42 | Car Seat |
| 52 | Additional Embodiment |
| 54 | Outer Covering |
| 56 | Arcuate Edge |
| 58 | Straight Edge |
| 62 | Front Side |
| 64 | Back Side |
| 66 | Opening |
| 68 | Fastener |
| 72 | First Wing Portion |
| 74 | Distal End First Wing Portion |
| 76 | Second Wing Portion |
| 78 | Distal End of Second Wing Portion |
| 82 | Head Rest Cover |
| 84 | First Fastening Member |
| 86 | Second Fastening Member |
| 88 | Third Fastening Member |
| 92 | Foam Insert |
| 94 | First Wing Portion of Insert |
| 96 | Second Wing Portion of Insert |
| 98 | Head Rest Portion Insert |
| 102 | Vehicle Seat |
| 104 | Head Rest Vehicle Seat |
| 108 | Fourth Fastening Member |

### DETAILED DESCRIPTION OF THE DRAWINGS

The present disclosure relates to a headrest system. The system includes a headrest that maintains a user's head in a vertical or near vertical orientation while the user is resting or sleeping. The headrest can be attached to a car seat, airline seat, automobile set, booster seat, or high chair via fasteners, such as hook and pile fasteners. The various details of the present invention, and the manner in which they interrelate, are described in greater detail hereinafter.

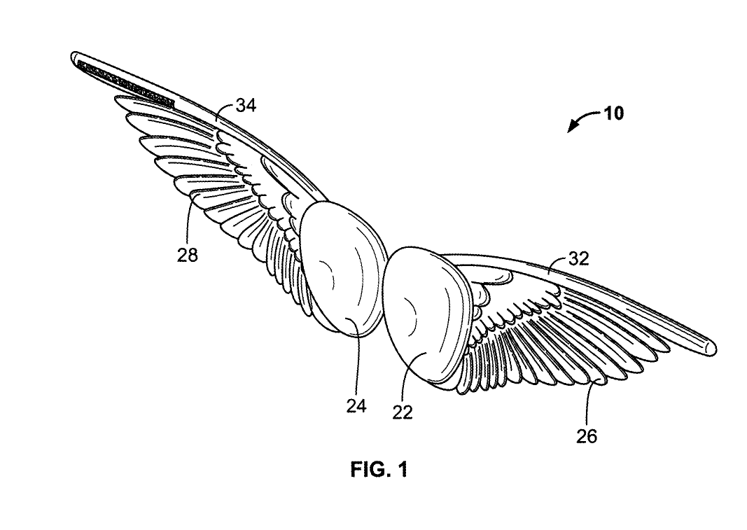

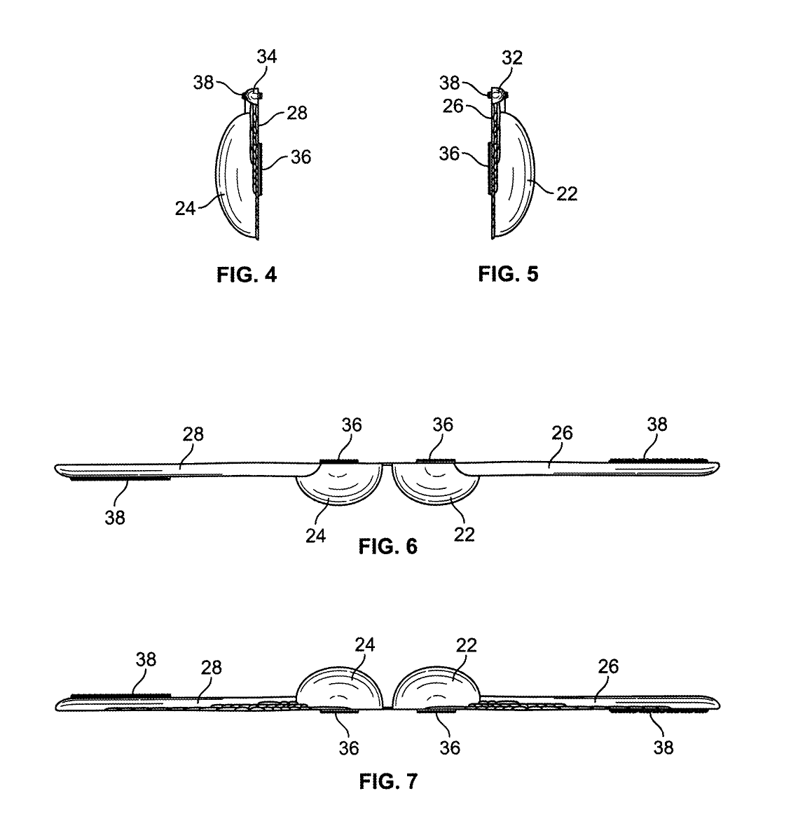

FIGS. 1-8 depict a headrest system 10 that is particularly adapted to be secured about the head of an infant. System 10 includes two opposing headrest portions that can be independently fitted to a seat. The headrest includes first and second pillows (22 and 24, respectively). Preferably these are memory foam type pillows and are constructed from a material that conforms to the infant's head or face. The first and second pillows (22 and 24) are integrally connected to first and second wing members (26 and 28, respectively). In the depicted embodiment, first and second wings (26 and 28) are decoratively configured into the shape of bird or angle wings. Other arrangements that are pleasing to a caregiver and that capture a child's imagination can also readily be used. Ideally these first and second wings (26 and 28) each have an upper rigid edge. Specifically, first wing 26 includes an upper rigid edge 32, and second wing 28 includes an upper rigid edge 34. Upper edges (32 and 34) may include an internal stiffening member to provide rigidity. The lower edges of the first and second wings (26 and 28) need not be rigid.

With reference now to FIG. 3, the backside of each of the pillow (22 or 24) includes hook and pile fastener elements 36. In one non-limiting example, Velcro™ brand fasteners are used. In the depicted embodiment, fasteners 36 are in the shape of an “I”. Other configurations for fasteners 36 can also be employed. Although Velcro™ is disclosed in a preferred embodiment, any other suitable hook and pile fastening system can be employed. Fasteners 36 allow each of the pillows (22 or 24) to be independently secured to a fabric car seat, booster seat, or high chair. Ideally the fabric on the seat includes a pile that can be secured to corresponding loops within fasteners 36. Alternatively, the seat to which the pillows (22 and 24) are attached can include mating hook and pile fasteners that are secured to fasteners 36.

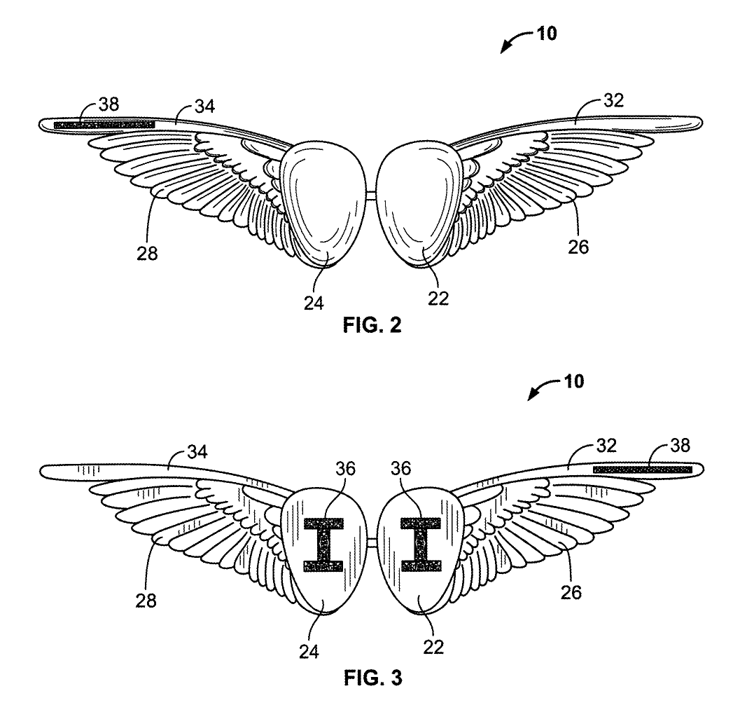

With reference to FIGS. 2 and 3, each of the upper edges 32 and 34 includes corresponding hook and pile fasteners 38. One length of fastener 38 is secured to back side of edge 32, while another length of fastener 38 is secured to the front side of edge 34. These two lengths of fasteners 38 are adapted to be releasably secured to one another. Again hook and pile fasteners 38 may preferably take the form of Velcro™ brand fasteners. These hook and pile fasteners 38 allow the two upper edges (32 and 34) to be joined together about the head of the child.

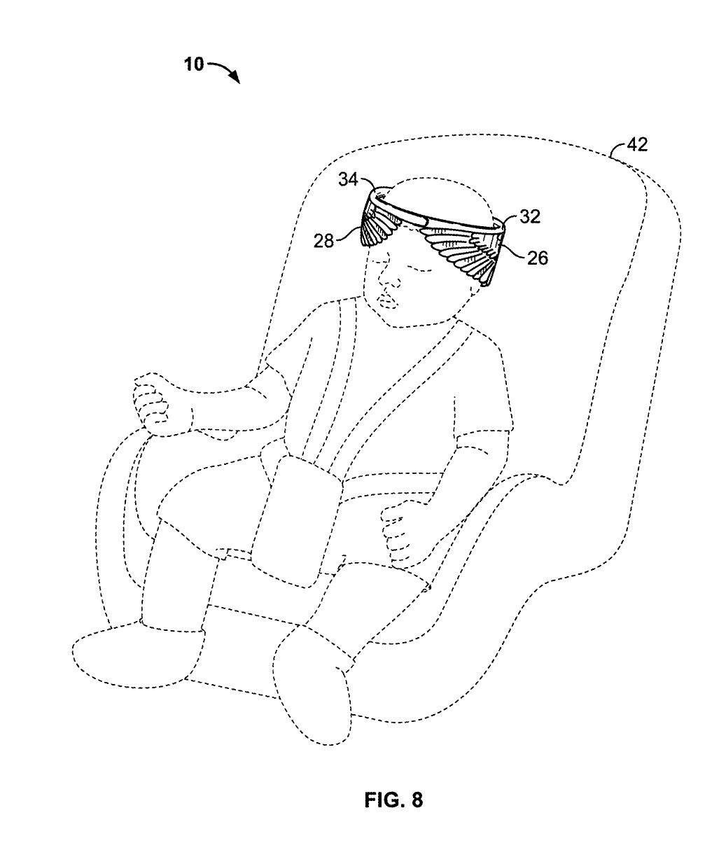

FIG. 8 illustrates the system 10 in place upon a car seat 42. Although not specifically shown, each of the pillows (22 and 24) is secured to the backrest of seat 42 via the hook and pile fasteners 36. Ideally, the front side of pillows (22 and 24) are oriented so that they support the back of the infant's head. Alternatively, pillows (22 and 24) can be secured to the opposite sides of seat 42. Thereafter the two upper edges (32 and 34) can be brought together in over lapping fashion around the upper circumference of the child's head. Edges (32 and 34) and then secured together with hook and pile fasteners 38. With this arrangement, the infant's head is secured and otherwise prevented from bobbing forward, backward, or side to side.

Other variations to the above described embodiment are also within the scope of the present invention. For example, pillows (22 and 24) can be eliminated and first and second wings (26 and 28) can be permanently attached to the car seat 42. This can be accomplished, for example, by securing wings (26 and 28) to the car seat 42 in a non-removable manner via stitching and/or adhesives. In a further possible variation, pillows (22 and 24) are included but are likewise permanently secured to the car seat 42. In still yet another variation, the width of the wings (26 and 28) can be adjusted. In the embodiment depicted in FIG. 8, the wings (26 and 28) extend over the forehead of the infant. However, wings (26 and 28) can optionally have a greater width such that they cover, or partially cover, the infant's eyes. This embodiment would eliminate or reduce sunlight in the infant's eyes and otherwise promote sleep.

### Alternative Embodiment

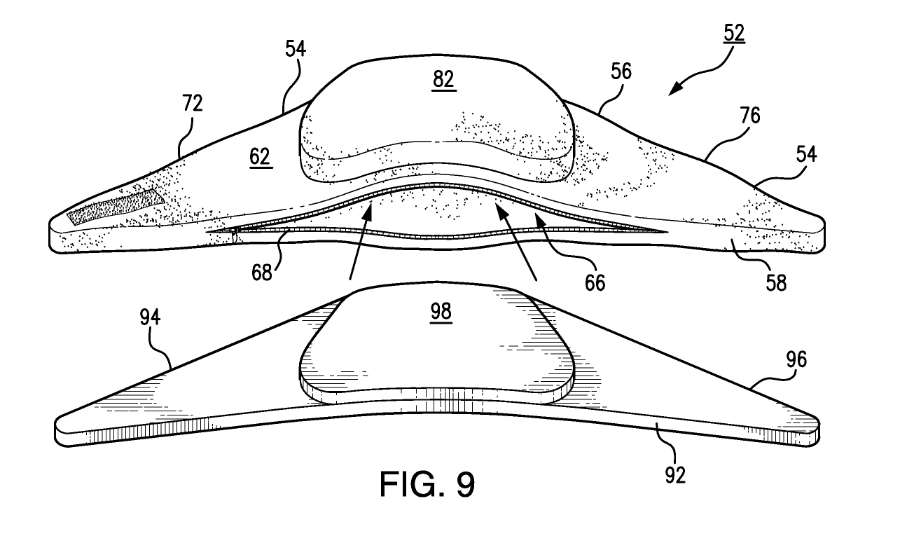

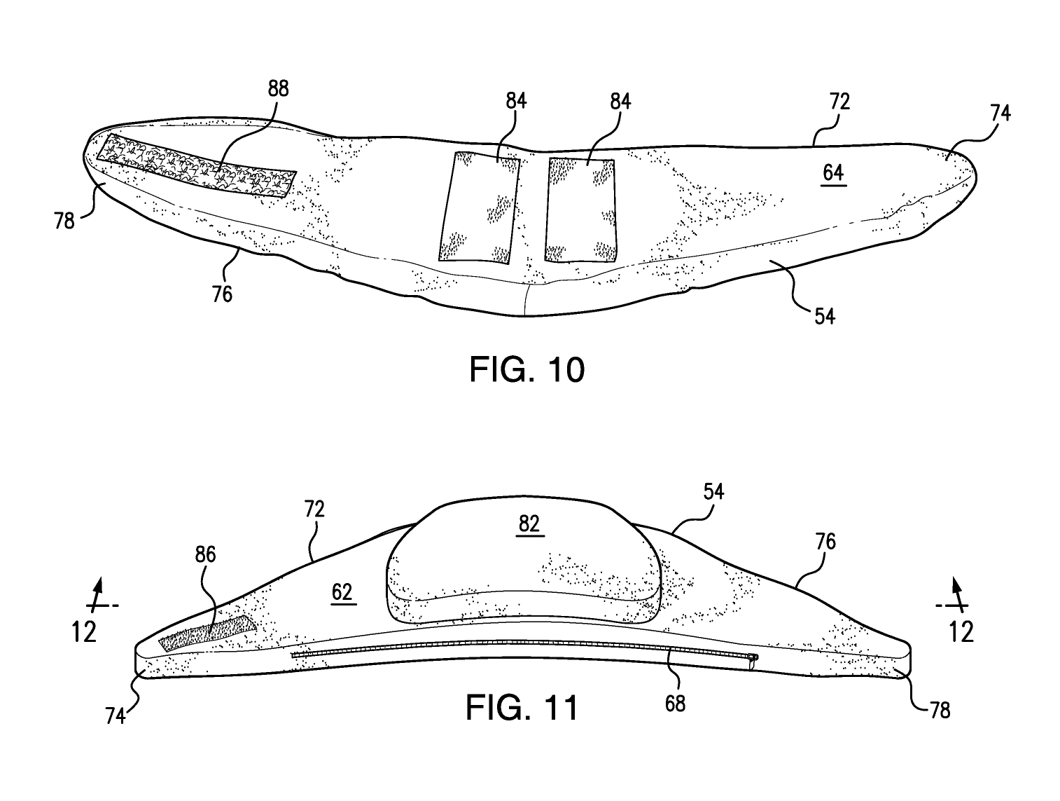

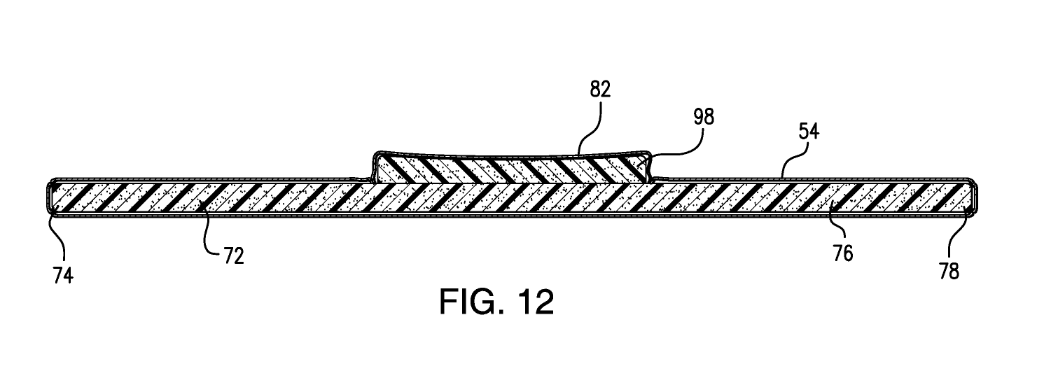

An alternative embodiment of the head rest system (52) is illustrated in FIGS. 9-13. This embodiment is the same in many respects as the embodiment of FIGS. 1-8. However, the alternative embodiment (52) includes an outer fabric covering and an interior foam insert. The alternative embodiment (52) likewise includes an enlarged headrest portion. As with the primary embodiment, this alternative embodiment can be sized and/or modified as necessary in order to support the head of users of varying sizes, including adults, adolescents, toddlers, or infants.

System (52) includes a cloth outer covering (54) with opposing upper and lower edges. In the depicted embodiment, covering (54) includes a first generally curved, or arcuate, edge (56), and a second generally straight edge (58). Outer covering (54) is further defined by front and back sides (62 and 64). An opening (66) is optionally formed within the generally straight edge (58). A fastener (68), such as a zipper of Velcro™ fastener, can be included for releasably closing the opening (66).

Outer covering (54) further includes first and second opposing wing portions (72 and 76). As described below, these wing portions (72 and 76) can be secured in overlapping fashion about the head of the user. This allows the head to be supported in a vertical or near vertical orientation while the user is resting or sleeping. Each of the wing portions (72 and 76) is defined by a distal end (74 and 78), which is the end furthest from the central portion of the cover (54). A headrest portion (82) is formed along the front side (62) of the outer covering (54) intermediate the first and second wing portions (72 and 76). This headrest portion (82) is formed by an extra portion of covering that extends outwardly from the front side (62) of the covering (54). As explained below, portion (82) allows an additional amount of foam padding to be positioned at the back of the user's head. In the preferred embodiment, covering (54) is formed from a Cuddle 3 fabric made by PICO textiles. The preferred length is from 58 inches to 60 inches. The fabric is preferably hypo-allergenic and non-shedding.

Various fasteners are included for both securing the covering (54) to an associated vehicle seat and for releasably securing together the first and second wing portions (72 and 76). In a preferred but non-limiting embodiment, these fasteners are hook and pile fasteners, such as Velcro™ brand fasteners. These are preferably heavy duty fasteners to withstand the elevated temperatures that may be encountered within a vehicle. The use of other types of fasteners is also within the scope of the present invention. For instance, snap-type fasteners, zippers, or various adhesives could similarly be used. Nonetheless, hook and pile fasteners are depicted and described herein.

More specifically, a first of hook and pile fastening member (84) is secured to the back side (64) of the outer covering (54) at a location opposite of the headrest portion (82). A pair of fasteners can also be employed to increase the force by which the head rest is secured. A second hook and pile fastening member (86) is secured to the front side (62) of the outer covering (54) at the distal end (74) of the first wing portion (72), and a third hook and pile fastening member (88) secured to the back side (64) of the outer covering member (54) at the distal end (78) of the second wing portion (76). As noted below, the second and third fastening members (86 and 88) are brought together to place the first and second wings (72 and 76) in overlapping relation. In each case, the hook and pile fasteners can be securing to cover (54) via stitching. It is preferred that such stitching is slightly recessed to provide a smooth surface.

FIG. 9 depicts the memory foam insert (92) that forms part of the present invention. This foam insert (92) includes first and second wing portions (94 and 96) and a headrest portion (98). These portions generally match the size and shape of the corresponding elements of the cover (54). As illustrated, foam insert (92) is adapted to be positioned through the opening (66) and within the outer covering (54). Once inserted, the respective first and second wing portions (72, 76, 94, 96) and respective head rest portions (82 and 98) can be positioned and orientated such that they are in alignment. In the preferred embodiment, head rest portion (82) of covering (54) and head rest portion (98) of the insert (92) are formed with a slight concave indentation to provide a more comfortable surface for the user's head.

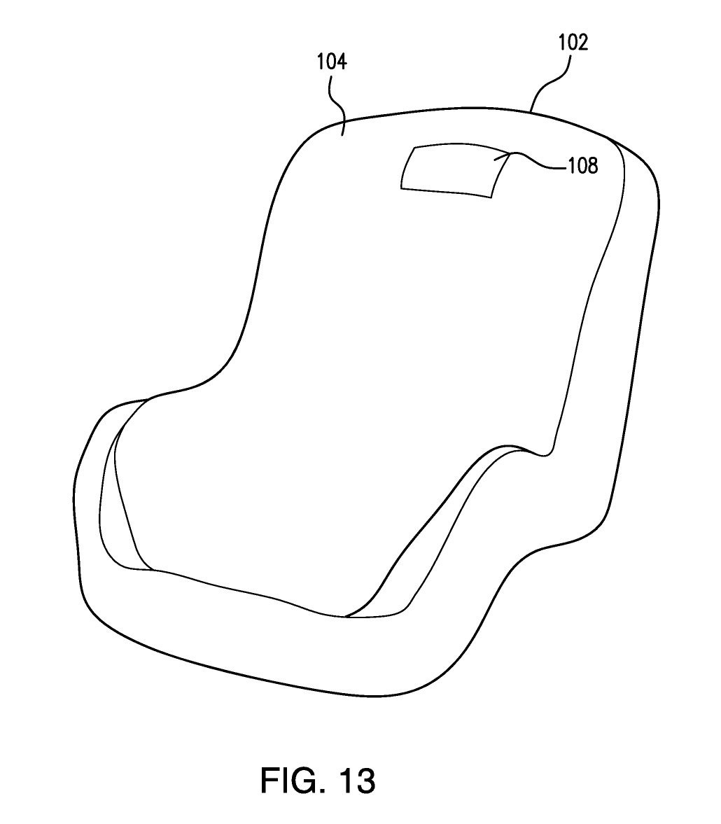

Cover (54) with the insert (92) are designed to be attached to a vehicle seat (102), and more particularly to a head rest (104) upon the seat (102) (note FIG. 13). Vehicle seat (102) can be the seat used within any of a variety of vehicles. For instance, seat (102) can be an airline seat or car seat. Seat (102) can also be a infant seat or high chair. In any event, seat (102) includes a fourth hook and pile fastening member (108) that is preferably secured to the head rest (104) portion. Adhesive attachment means can be used to secure the fourth fastening members (108) to head rest (104). An additional layer of adhesive, such as a WeldBond™ brand liquid adhesive, can also be included to ensure that the bond withstands heat and repeated use. The first and fourth hook and pile fastening members (84 and 108) can be releasably secured to one another. This allows cloth outer covering (54) (with the foam insert (92)) to be releasably secured to the head rest (104) of the vehicle seat (102).

System (52) is preferably used as follows. Foam insert (92) is first positioned within the outer covering (54). Thereafter, first and fourth fasteners (84 and 108) are secured together to thereby releasably attach covering (54) to seat (102). Next, the second and third hook and pile fastening members (86 and 88) are secured together. In securing these members together, the first and second wing portions (72 and 76) are secured in overlapping relation about the head of the user. In this manner, the user's head is kept upright, at a vertical or near vertical orientation, while seated. This allows the user to rest or sleep without having to fully recline.

In still yet another embodiment, the first and fourth hook and pile fastening members (84 and 108) are eliminated. Instead of fasteners, the outer covering (54) is affixed to the head rest (104) of vehicle seat (102). More specifically, the back side (64) of covering (54) is fixed to head rest (104) by stitching. Namely, stitching can be used to join covering (54) to a fabric covering on seat (102). A permanent adhesive may also be used. It is also within the scope of the present invention to provide a covering (54) and insert (92) of an increased length. This would allow the covering (54) with insert (92) to be wrapped about the back of the vehicle seat (102) and secured via second and third fasteners (86 and 88). This embodiment may be used, for example, around an airline seat.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A headrest system (52) for supporting the head of a user while sleeping or resting, the system (52) comprising in combination:
a cloth outer covering (54) with a generally arcuate edge (56), a generally straight edge (58), a front side (62) and a back side (64), an opening (66) formed within the generally straight edge (58), a fastener (68) for releasably closing the opening (66) formed within the generally straight edge (58), the outer covering (54) further including first and second opposing wing portions (72 and 76), each of the wing portions (72 and 76) having a distal end (74 and 78), a headrest portion (82) formed along the front side (62) of the outer covering (54) intermediate the first and second wing portions (72 and 76);
a first of hook and pile fastening member (84) secured to the back side (64) of the outer covering (54) at a location opposite of the headrest portion (82), a second hook and pile fastening member (86) secured to the front side (62) of the outer covering (54) at the distal end (74) of the first wing portion (72), a third hook and pile fastening member (88) secured to the back side (64) of the outer covering member (54) at the distal end (78) of the second wing portion (76);
a memory foam insert (92), the foam insert (92) having first and second wing portions (94 and 96) and a headrest portion (98), the foam insert (92) positioned through the opening (66) and within the outer covering (54) with the respective first and second wing portions (72, 76, 84, 96) and head rest portions (82 and 98) being in alignment;
a vehicle seat (102) having a head rest (104), a fourth hook and pile fastening member (108) secured to the head rest (104) of the vehicle seat (102), the first and fourth hook and pile fastening members (84 and 108) being releasably secured to one another such that the cloth outer covering (54) with the foam insert (92) are releasably secured to the head rest (104) of the vehicle seat (102);
whereby the second and third hook and pile fastening members (86 and 88) can be secured together such that the first and second wing portions (72 and 76) are secured in overlapping relation about the head of the user.

2. A headrest system for a user comprising:
a cover with front and back sides and first and second wings, a headrest portion formed along the front side intermediate the first and second wings;
a first fastening means secured to the front side of the cover at the first wing, a second fastening means secured to the back side of the outer covering member at the second wing;
a foam insert positioned within the cover;
a vehicle seat having a head rest, the head rest of the cover being attached to the head rest of the vehicle seat;
whereby the first and second fastening means can be secured together such that the first and second wings are secured in overlapping relation about the head of the user.

3. The head rest system as described in claim 2 wherein the first and second fastening means are hook and pile type fasteners.

4. The head rest system as described in claim 2 wherein the first and second fastening means are snap type fasteners.

5. The head rest system as described in claim 2 wherein the cover is releasably attached to the vehicle seat via a hook and pile fastener.

6. The head rest system as described in claim 2 wherein the cover is permanently affixed to the vehicle seat via stitching.

7. The head rest system as described in claim 2 wherein the vehicle seat is an airline seat.

8. The head rest system as described in claim 2 wherein the vehicle seat is an infant car seat.

9. The head rest system as described in claim 2 wherein the insert is made from a memory foam.

10. A headrest system for a user comprising:
a vehicle seat having a head rest portion;
a memory foam pillow secured to the head rest portion of the vehicle seat, the memory foam pillow having first and second wings;
whereby the first and second wings can be secured together such that the first and second wings are secured in overlapping relation about the head of the user.
